(19) United States
(12) Patent Application Publication
(10) Pub. No.: US 2008/0096545 A1
(43) Pub. Date: Apr. 24, 2008

(54) Peer-to-peer cellular network

(76) Inventor: Bruno Delean, Andorra La Vella (FR)

Correspondence Address: Soquel Group, LLC, P.O. Box 691, Soquel, CA, 95073, US

(21) Appl. No.: 11/585,318

(22) Filed: Oct. 23, 2006

(51) Int. Cl. H04Q 7/20

(52) U.S. Cl. 455/424

(57) ABSTRACT

A network for cellular communication comprising a plurality of cellular receiver/transmitters, each one of which having a position, P, associated therewith and including a receiver for receiving a radio broadcast message in route to a destination, D, over a free frequency using time division multiple access (TDMA), and a transmitter for transmitting a message to another cellular receiver/transmitter, over a free frequency using time division multiple access (TDMA), a local positioning system for identifying other cellular receiver/transmitters positioned within a vicinity of P, and a router for determining a one of the identified other cellular receiver/transmitters that has a position, Q, that is closer to D than P is. A method and a computer-readable storage medium are also described and claimed.

### FIELD OF THE INVENTION

The present invention relates to cellular communication.

### BACKGROUND OF THE INVENTION

Time division multiple access (TDMA) is a digital transmission technology that splits a single radio-frequency (RF) channel into time slots, so as to multiplex three signals over a single channel. TDMA enables three users to share the same RF channel, thereby achieving a 3:1 gain in capacity over analog transmission. TDMA makes efficient utilization of hierarchical cell structures, which are used to customize transmission systems to support specific traffic and service needs. It is anticipated that TDMA will soon be enhanced to support more than 40 times the capacity of analog transmission.

TDMA is also advantageous in that it is compatible with analog systems, and thus enables service compatibility with dual-mode handsets. Using dual-mode dual-band phones, subscribers on a TDMA channel can hand off to/from a TDMA channel and to/from an analog channel.

Thus it is expected that tomorrow's “super-capacity” TDMA transmission will enable a variety of communication applications that are not commercially possible today. The present invention addresses some of these applications.

### SUMMARY OF THE DESCRIPTION

The present invention concerns a cellular communication technology that operates on free RF channels by using a series of intermediate receivers/transmitters. Familiar devices such as walkie-talkies are able to use free RF channels because of the short ranges over which voice is transmitted. The present invention is able to achieve long range wireless voice transmission over the same free RF channels, by using TDMA transmission technology.

There is thus provided in accordance with an embodiment of the present invention a network for cellular communication comprising a plurality of cellular receiver/transmitters, each one having a position, P, associated therewith and including a receiver for receiving a radio broadcast message in route to a destination, D, over a free frequency using time division multiple access (TDMA), and a transmitter for transmitting a message to another cellular receiver/transmitter, over a free frequency using TDMA, a positioning system for identifying other cellular receiver/transmitters positioned within a vicinity of P, and a router, coupled with the positioning system, for determining a one of the identified other cellular receiver/transmitters that is closer to D than P is.

There is moreover provided in accordance with an embodiment of the present invention a method for cellular communication including receiving, by a cellular receiver/transmitter located at a position P, a radio broadcast message in route to a destination, D, over a free radio frequency, using time division multiple access, identifying other cellular receiver/transmitters positioned within a vicinity of P, determining a one of the identified other cellular receiver/transmitters that has a position, Q, that is closer to D than P is, and transmitting the received message to the cellular receiver/transmitter positioned at Q.

There is further provided in accordance with an embodiment of the present invention a computer readable storage medium storing program code for causing a computer to receive, by a cellular receiver/transmitter located at a position P, a radio broadcast message in route to a destination, D, over a free radio frequency, using time division multiple access, to identify other cellular receiver/transmitters positioned within a vicinity of P, to determine a one of the identified other cellular receiver/transmitters that has a position, Q, that is closer to D than P is, and to transmit the received message to the cellular receiver/transmitter positioned at Q.

### BRIEF DESCRIPTION OF THE DRAWINGS

The present invention will be more fully understood and appreciated from the following detailed description, taken in conjunction with the drawings in which:

FIG. 1 is a simplified illustration of a free cellular network, in accordance with an embodiment of the present invention;

FIG. 2 is a simplified flowchart of a method for communication over free RF channels, in accordance with an embodiment of the present invention; and

FIG. 3 is a simplified block diagram of a receiver/transmitter cell, in accordance with an embodiment of the present invention.

### DETAILED DESCRIPTION

The present invention relates to wireless voice communication over free RF channels. Whereas conventional walkie-talkie devices that use free RF channels are limited to short range communication, the present invention uses a series of intermediate receiver/transmitter cells to provide for long range communication.

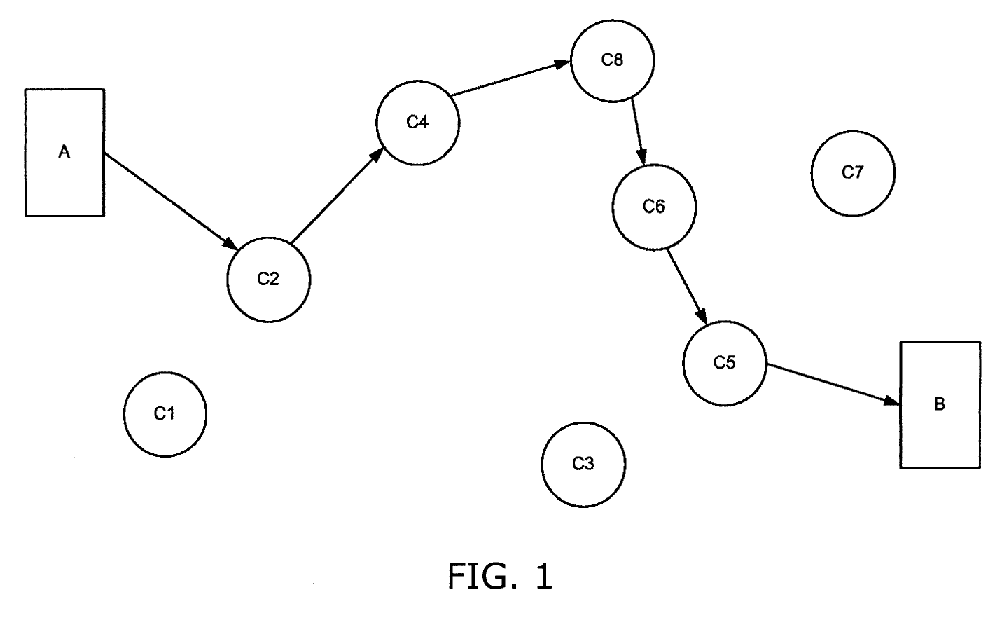

Reference is now made to FIG. 1, which is a simplified illustration of a free cellular network including cellular telephones A and B, and receiver/transmitter cells C1-C8, in accordance with an embodiment of the present invention. Telephones A and B and receiver/transmitter cells C1-C8 send messages using TDMA via free RF channels over limited ranges.

Each receiver/transmitter cell Cm is equipped with a positioning device, such as a global positioning system (GPS) device, that identifies the position of Cm and the positions of all active receiver/transmitter cells C1-C8 that are within the limited range of Cm. If Cm receives a voice message intended for a telephone at destination D, Cm relays the message, via TDMA, to the telephone, if D is within the limited range of Cm. Otherwise, if D is not within the range of Cm, then Cm relays the message, via TDMA, to a receiver/transmitter cell Cn that is closer to D than is Cm. Using shorthand notation, either Cm→D or else Cm→Cn, where Cn is closer to D that is Cm. If D is not within range of Cm, and if there are no active cells Cn closer to D than is Cm, the Cm uses the dual mode capability of TDMA to send the message to destination D using analog transmission.

If there are several candidate cells Cn that are closer to D than is Cm, then Cm may select (i) the candidate cell Cn that is closest to D, (ii) the first candidate cell Cn that is identified by Cm as being closer to D than is Cm, or (iii) the first candidate cell Cn that is identified as being closer to D by a prescribed amount, such as 5 miles, than is Cm, if such a cell Cn exists.

Shown in FIG. 1 is a communication path that originates at a cellular telephone A and travels through intermediate receiver/transmitter cells C2, C4, C8, C6 and C5, until it reaches its final destination, telephone B. Each successive cell in the path is closer to telephone B that the previous cell.

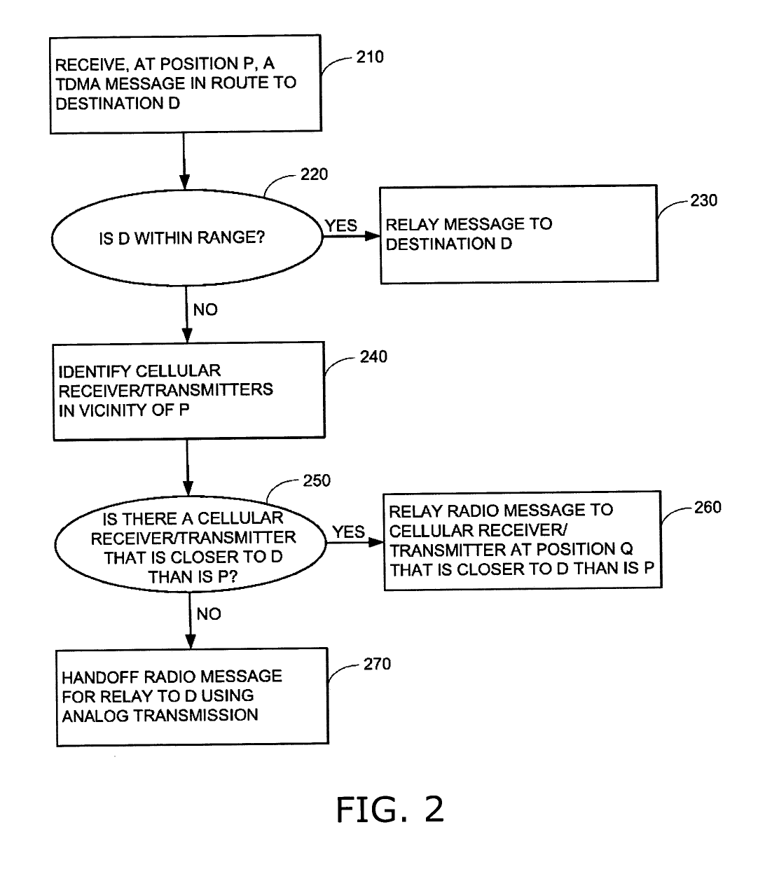

Reference is now made to FIG. 2, which is a simplified flowchart of a method for communication over free RF channels, in accordance with an embodiment of the present invention. The flowchart of FIG. 2 is performed by an intermediate receiver/transmitter cell located at a position P, that receives a TDMA communication intended for a telephone at destination D. At step 210 the cell receives a TDMA message over a free RF channel, in route to destination D. At step 220 the cell determines whether D is within its limited range. If so, then at step 230 the cell relays the message to its final destination, D, via TDMA. Otherwise, if D is not within range of the cell, then at step 240 the cell identifies active receiver/transmitter cells that are within its limited range.

At step 250 the cell determines if it is able to locate another active cell that is closer to D than is P. If so, then at step 260 the cell relays the message to an active cell at a position Q that is closer to D than is P, via TDMA. The cell at position Q then follows steps 210-260. If destination D is not within range of the cell, and if the cell cannot locate an active cell that is closer to D than is P, then at step 270 the cell uses the dual mode capability of TDMA to handoff the message for relay to its destination D using analog transmission.

It will be appreciated that the positions of telephones A and B, and the positions of the receiver/transmitter cells are generally moving and not stationary.

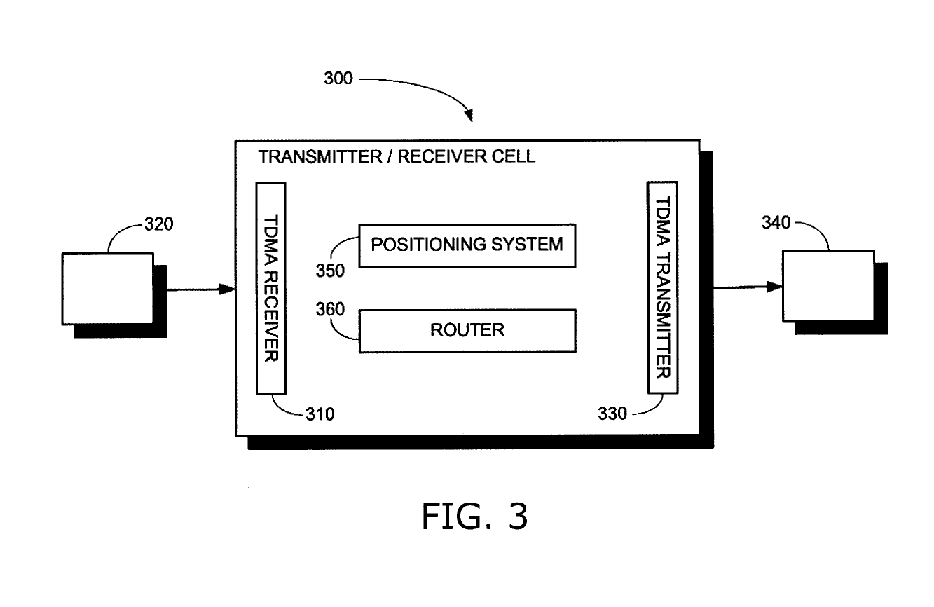

Reference is now made to FIG. 3, which is a simplified block diagram of a receiver/transmitter cell 300, in accordance with an embodiment of the present invention. Shown in FIG. 3 is a TDMA receiver 310, for receiving a TDMA message from a telephone or from another receiver/transmitter cell 320, transmitted over a free RF channel, intended for a destination, D. Also shown is a TDMA transmitter 330, for transmitting the received message to its intended destination, D, or to another receiver/transmitter cell 340 for further transmission.

Cell 300 includes a positioning system 350 for identifying the position of cell 300, and for identifying positions of other cells, such as cells 320 and 340. Cell 300 also includes a router 360 for determining to which node within range of cell 300 should cell 300 relay the received message. If destination D is within range for cell 300, then router 360 indicates that cell 300 should relay the received message to its final destination, D. Otherwise, if destination D is not within range for cell 300, then router 360 indicates that cell 300 should relay the received message to another cell, such as cell 340, which is closer to the destination, D, than is cell 300.

The method and system illustrated in FIGS. 2 and 3 are not practical with today's digital transmission capacity, because the latency in messages traveling between a series of some number, n, of intermediate cells is not acceptable. However, when TDMA reaches 40 times analog capacity, as is predicated, the latency will be reduced dramatically, so that a message that travels through a series of up to 40 intermediate cells will be received at today's analog rates.

In reading the above description, persons skilled in the art will realize that there are many apparent variations that can be applied to the methods and systems described. Thus, in addition to voice communication, the present invention applies to other forms of peer-to-peer digital communication, including inter alia text messaging, music, photo and video communication, and interactive games.

It may also be appreciated that the present invention is not restricted to TDMA transmission, and applies to any digital transmission technology that can achieve a significant gain over analog transmission capacity, including the spread spectrum code division multiple access (CDMA) technology, which also splits the radio frequencies. The present invention also applies inter alia to narrowband analog mobile-phone services (NAMPS), and global system for mobile communications technologies.

In the foregoing specification, the invention has been described with reference to specific exemplary embodiments thereof. It will, however, be evident that various modifications and changes may be made to the specific exemplary embodiments without departing from the broader spirit and scope of the invention as set forth in the appended claims. Accordingly, the specification and drawings are to be regarded in an illustrative rather than a restrictive sense.

What is claimed is:

1. A network for cellular communication comprising a plurality of cellular receiver/transmitters, each one having a position, P, associated therewith and comprising:
a receiver for receiving a radio broadcast message in route to a destination, D, over a free frequency using time division multiple access (TDMA); and
a transmitter for transmitting a message to another cellular receiver/transmitter, over a free frequency using TDMA;
a positioning system for identifying other cellular receiver/transmitters positioned within a vicinity of P; and
a router, coupled with said positioning system, for determining a one of the identified other cellular receiver/transmitters that is closer to D than P is.

2. The network of claim 1, wherein said router determines a one of the identified other cellular receiver/transmitters that is closest to D.

3. The network of claim 1, wherein said router determines a one of the identified other cellular receiver/transmitters that is closer to D than P is by at least a predetermined distance.

4. A method for cellular communication comprising:
receiving, by a cellular receiver/transmitter located at a position P, a radio broadcast message in route to a destination, D, over a free radio frequency, using time division multiple access;
identifying other cellular receiver/transmitters positioned within a vicinity of P;
determining a one of the identified other cellular receiver/transmitters that has a position, Q, that is closer to D than P is; and
transmitting the received message to the cellular receiver/transmitter positioned at Q.

5. The method of claim 4, wherein said determining determines a one of the identified other cellular receiver/transmitters that is closest to D.

6. The method of claim 4, wherein said determining determines a one of the identified other cellular receiver/transmitters that is closer to D than P is by at least a predetermined distance.

7. A computer readable storage medium storing program code for causing a computer:
to receive, by a cellular receiver/transmitter located at a position P, a radio broadcast message in route to a destination, D, over a free radio frequency, using time division multiple access;
to identify other cellular receiver/transmitters positioned within a vicinity of P;
to determine a one of the identified other cellular receiver/transmitters that has a position, Q that is closer to D than P is; and
to transmit the received message to the cellular receiver/transmitter positioned at Q.
